(19) United States
(12) Patent Application Publication
(10) Pub. No.: US 2015/0223526 A1
(43) Pub. Date: Aug. 13, 2015

(54) Knot Rlaxed

(71) Applicant: Martina Hilary Nolan, Fairfield, CT (US)

(72) Inventor: Martina Hilary Nolan, Fairfield, CT (US)

(21) Appl. No.: 14/175,874

(22) Filed: Feb. 7, 2014

(51) Int. Cl. A41D 1/04; A61H 1/00; A41D 27/20

(52) U.S. Cl. CPC A41D 1/04; A41D 27/20; A61H 1/008

(57) ABSTRACT

A fitted garment that covers specific muscle areas in the back area of the body. It is a spandex/cotton material with strategically placed pockets sewn into specific areas of the material. Inside these pockets, high-density foam therapeutic balls are placed to facilitate in massaging specific muscles in the back area of the body.

The garment fits securely to the upper body, and is secured by closing fitted straps and plastic buckles in the front area of the body. Because the garment is secured on the body, the person wearing it can move freely and with the use of their own body, they can apply pressure to the muscles by leaning against an object that would allow the balls to put pressure on these specific muscles. This process releases tension from the muscle and increases blood flow and range of motion. Because there are ten (10) pockets in specific areas of the garment, the same muscles are always being massaged allowing better relief and healthy blood flow to these muscles. The garment allows for the user to choose if they would like to use all the therapeutic balls at the same time or use only a few to massage certain muscles at certain times. The balls are interchangeable, allowing for this flexibility in use. Only high-density foam balls are used in this product, the pockets are sized to hold them in place for a greater therapeutic effect.

### CROSS REFERENCE AND RELATED APPLICATION

The invention is related to the invention described in Patent NO. US 2004/0153012 A1. Publish date Aug. 5, 2004.

### BACKGROUND OF THE INVENTION

The invention is fitted to the health field and is a uniquely designed garment that conforms to the upper body, with interchangeable therapeutic massaging balls, in strategically placed pockets.

The invention can alleviate soreness and tightness in the upper body, specifically the back muscles along the spine and upper Trapezes. The invention can also help in maintaining or increasing range of motion to the upper body. It can eliminate the need for expensive body massage and it is ideal for people of all ages from children who carry heavy backpacks, to adults who sit at computers for long period of times, frequent travelers, bedridden patients and very active exercise enthusiasts.

### SUMMARY OF THE INVENTION

Muscle problems that occur in the upper and lower back and neck area can be difficult to reach. If people do not release stress and tension in their back area they can develop headaches, sore muscles and a number of adverse health problems.

The user can simply place the therapeutic balls in the pockets, using as few or as many as needed. They can simply put on the garment and secure the straps in the front upper area of the body. The garment with the therapeutic balls in place can conform to the body providing a natural massage. Additionally when wearing the garment the user can lean against any firm stable object or surface, such as a wall, lay on the floor and this will facilitate in applying desired pressure to the muscle and by slight movement of the upper body from left to right, or an up and down motion, the user can begin to massage the muscles. Pockets for foam balls allow user to place balls in same place each time for better release and healing of muscles and pain relief. Because the invention is hands free good posture is held while massaging the specific muscles.

The invention allows the user to easily massage the muscles in the upper body, therefore stimulating blood flow while releasing tension and stress and alleviating soreness and tightness.

Because of the stimulation of blood flow, it can help the user avoid further injury and negative health effects. Being that the massage balls are interchangeable, the user does not have to use them all at the same time. For instance if tightness is felt in a muscle in the upper Trapezes area and the lower back feels good, the user need only place the therapeutic balls in that area to stimulate the tight muscle. Normally the 2.5″ balls are placed in the lower garment pockets, because of the curve in the lower back they can facilitate in massaging the Quadratus Lumborum, which attaches to the last rib and the Iliac Crest. It may also be easier to use the 2.5″ ball in the pockets that are situated in the upper Trapezes area because of how the muscle begins to attach to the occipital bone and Thoracic Vertebrae. These balls are bigger and can facilitate in stimulating the muscles in these areas more easily than the 1.5″ balls. Without the pockets in the garment, the therapeutic balls would not stay in place to massage those particular muscles at the same time. Other products that do not conform and are not secure on the body can cause the user to strain other muscles while trying to reach the back area. The foam massage balls are designed specifically for the pockets in the inventions garment.

The garment is lightweight, and does not cover the full area of the upper body therefore allowing free range of movement of the arms and not causing the user to feel too constricted while in use. The garment travels easily and is machine washable.

### DESCRIPTION OF THE INVENTION

The invention provides people with a simple and hassle free way to relieve stress and tension in the upper body while massaging the muscles. This innovative product may comprise the look of a small backpack made of a Spandex/cotton material. Sewn inside the garment are 10 strategically placed pockets. The pockets are in the particular area of the back, such as the upper Trapezes, Rhomboid area and Quadratus lumborum, which is in the lower back area. Inside each pocket a high density, reinforced foam therapeutic ball may be placed. 6 Woven straps made of Nylon material, are sewn attached to the sides and front of the vest. At the other end of each strap is a plastic buckle. The nylon strap is run through the mid portion of the plastic buckle, which has a small bar, and the nylon material is wrapped around that bar and sewn together to keep it secure to the buckle. These buckles are from a thermoplastic mold and snap closed together in the front area of the body. With the help of these straps and the plastic buckle, the garment is secure and contours to the body, but still allowing free movement of the upper body. The straps can be adjusted to size and comfort.

There are 10 foam therapeutic balls, 6 of which are 1.5″ in diameter and 4 are 2.5″ in diameter. These foam balls are made from a high-density molded polyethylene foam to allow the user to get more pressure without breaking apart. Because it is a high-density foam, they will not loose their shape with moderate to heavy use.

The garment can be offered in various sizes to accommodate all users. The garment is lightweight and is fixed to the body to prevent movement and irritation. When not in use a cotton bag comes with the invention to store the garment and the therapeutic balls.

### DESCRIPTION OF DRAWINGS

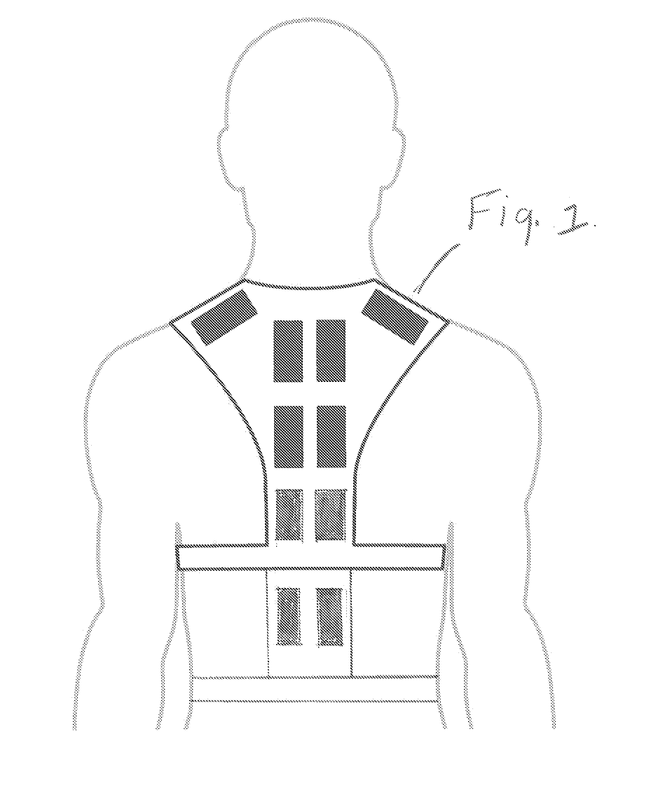

1. FIG. 1 Depicts back view of the garment when worn on the users body.

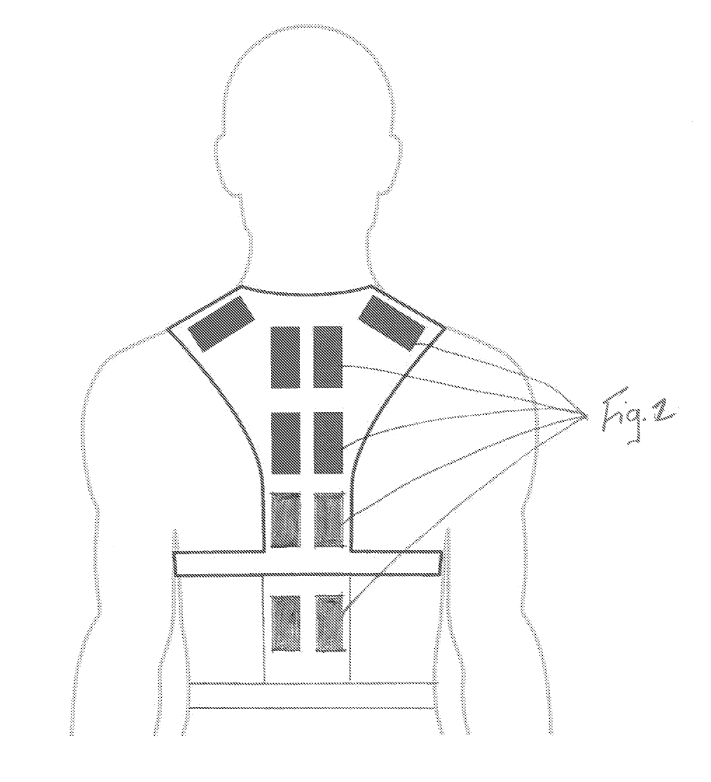

2. FIG. 2 Depicts pockets that are in the FIG. 1 and are along the outer area of the spine and upper Trapezes to facilitate in massaging and relaxing those specific muscles.

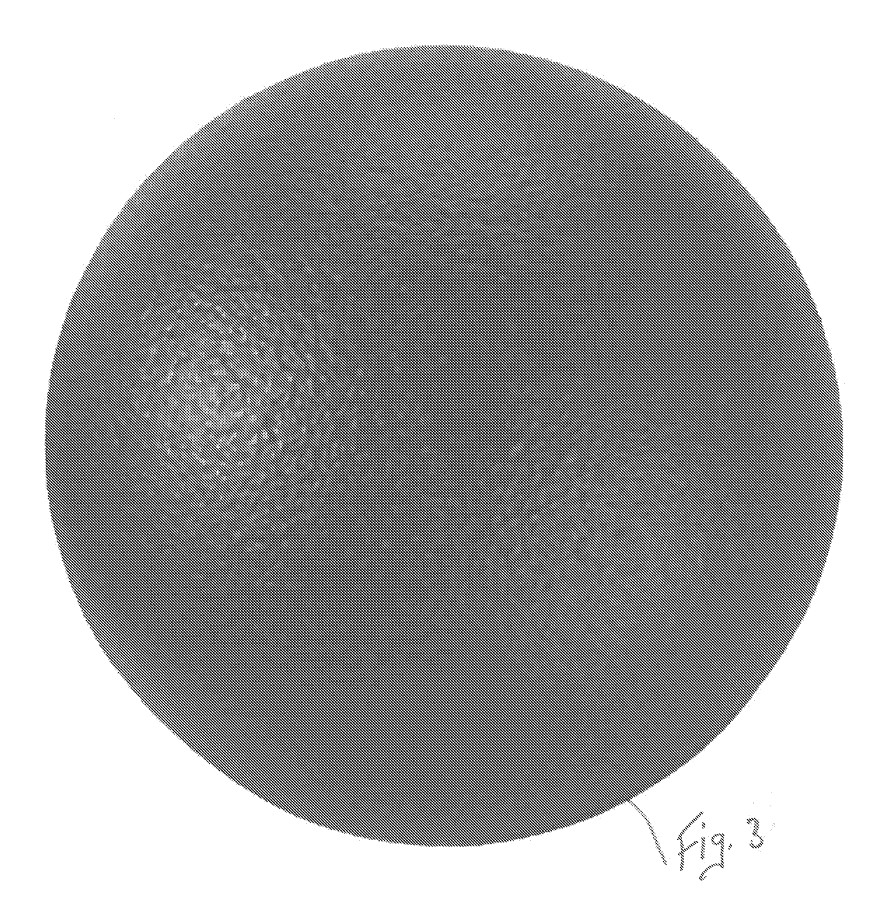

3. FIG. 3 Depicts the foam therapeutic ball.

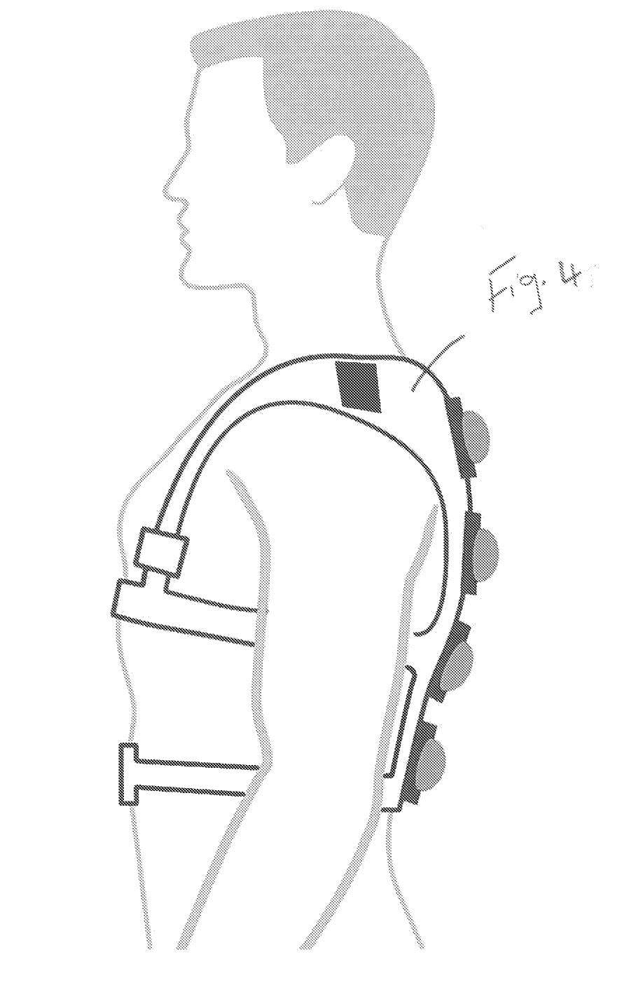

4. FIG. 4 Depicts a side view of FIG. 1 positioned on the users body.

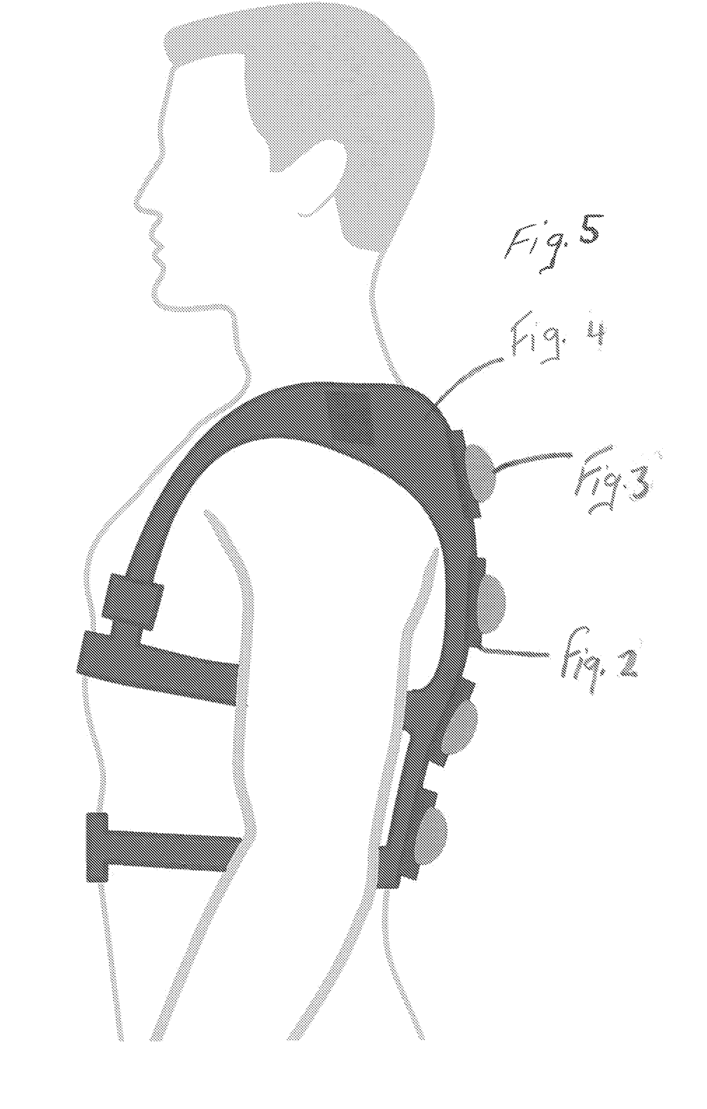

5. FIG. 5 Depicts a view of FIG. 4. when FIG. 3 the foam therapeutic balls are strategically placed inside FIG. 2 the pockets that hold the therapeutic balls in place on the outer area of the spine and Trapezes area.

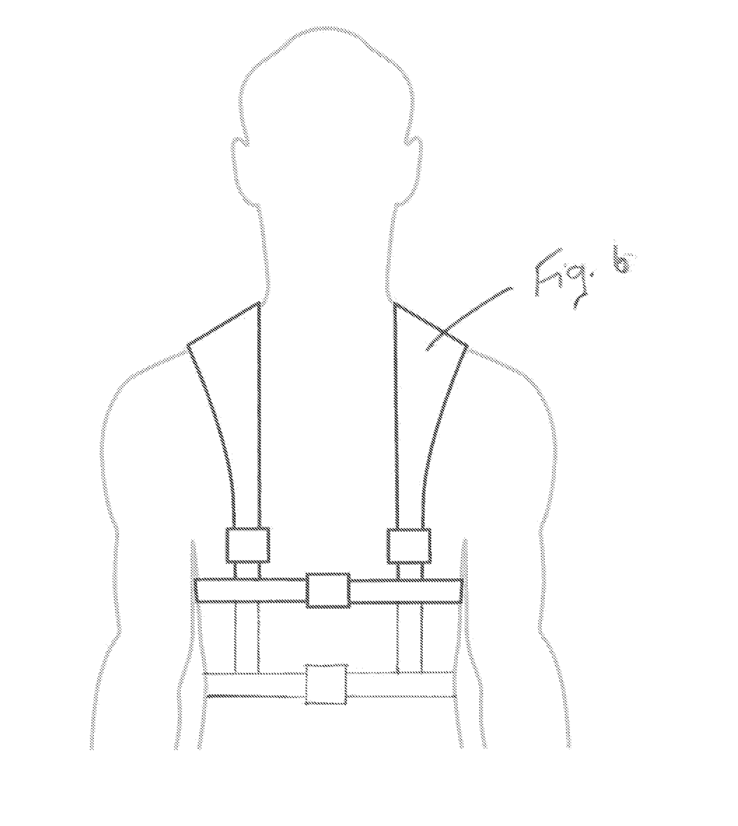

6. FIG. 6 Depicts the front view of the garment while worn on the users body.

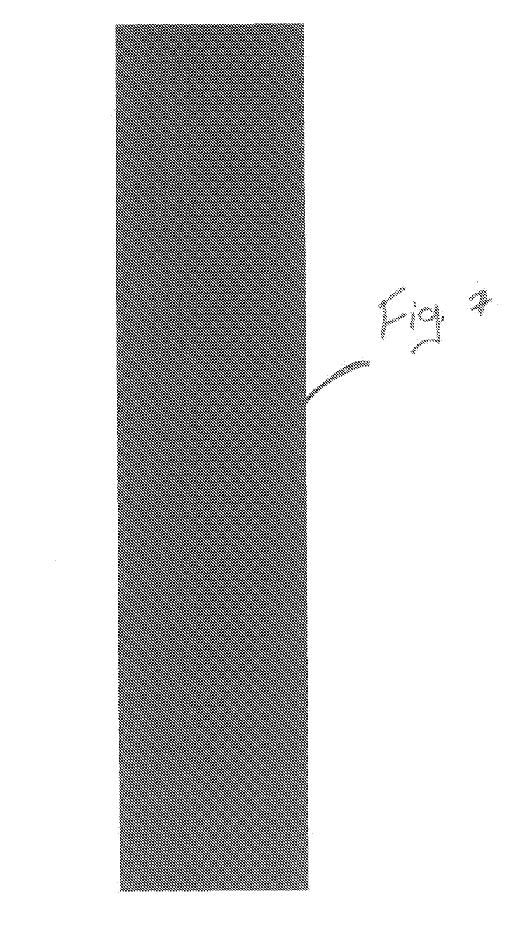

7. FIG. 7 Depicts the nylon strap.

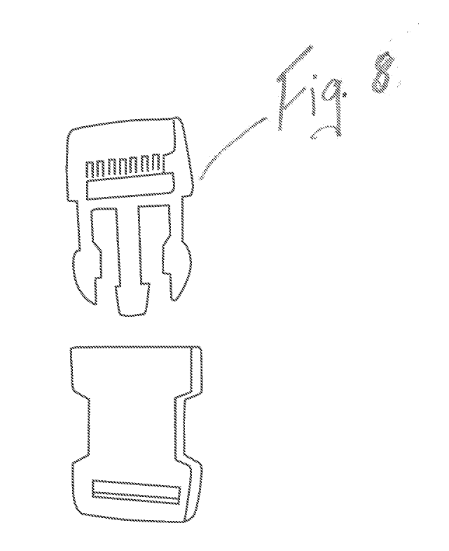

8. FIG. 8 Depicts plastic buckle.

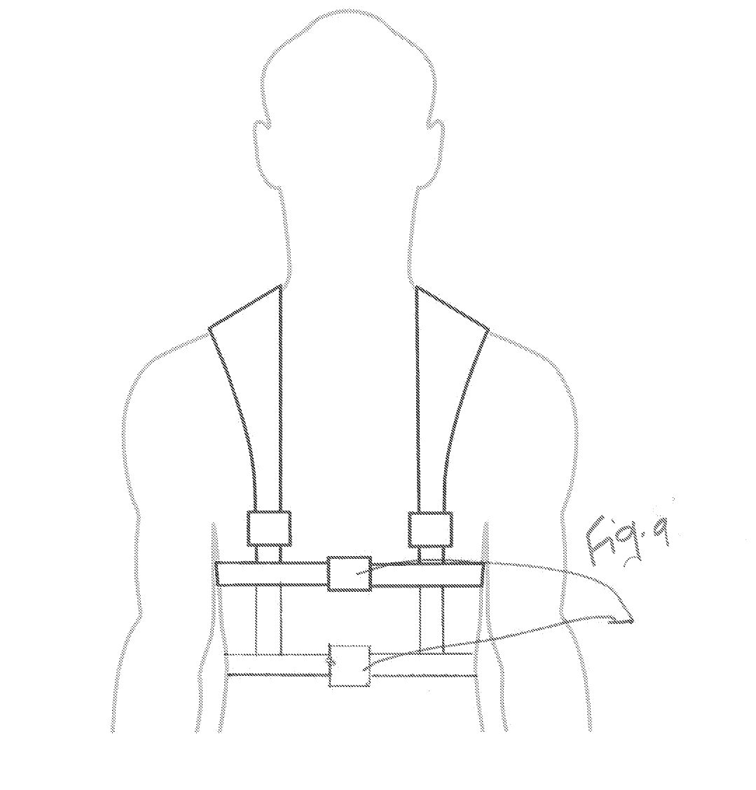

9. FIG. 9 Depicts the plastic buckle that is attached to one end of FIG. 7 that snaps closed to hold the garment securely on the users upper body.

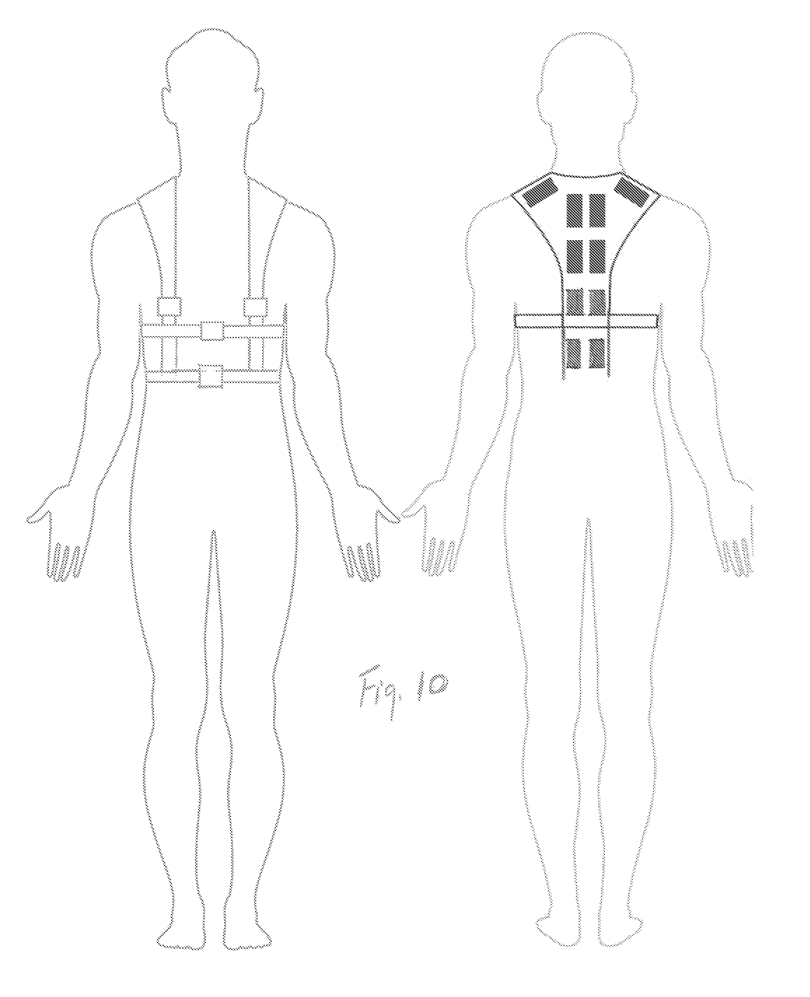

10. FIG. 10 Depicts front and back area of the garment.

1. The invention claim is a garment of Spandex/cotton material that conforms to the upper area of the body. Inside the back portion of the garment along the outside of the spine are 10 pockets in which therapeutic high density foam balls are placed, and the user with this invention can massage the upper and lower area of the back, stimulating blood flow and breaking down knots in the muscle, thereby causing the muscle to relax. Because of how the pockets are placed in the garment, the same muscles are massaged each time the therapeutic balls are placed in them, therefore allowing for better muscle relaxation. By leaning against a hard stable surface, and slightly moving the upper body from left to right or an up and down motion the process begins. The therapeutic balls range from 1.5″ to 2.5″. The therapeutic balls are interchangeable. The garment closes in the front area of the body with the aid of thin nylon straps with plastic buckles to hold in place securely on the body. The straps can be adjusted for comfort and the garment comes in a range of sizes. The garment does not cover the full area of back or front of the body. Pockets for high-density foam balls are located in the garment to the outer area of the spine and upper Trapezes.
